(19) United States
(12) Patent Application Publication
(10) Pub. No.: US 2009/0135952 A1
(43) Pub. Date: May 28, 2009

(54) Portable Terminal Having Automatic Searching Function For Broadcasting Channel And Method For Searching Broadcasting Channel Automatically In Portable Terminal

(76) Inventors: Dong-Ki Lee, Gyeonggi-do (JP); Hyun-Kuk Kim, Gyeonggi-do (KR)

Correspondence Address: HARNESS, DICKEY & PIERCE, P.L.C., P.O. BOX 8910, RESTON, VA, 20195, US

(21) Appl. No.: 12/224,985

(22) PCT Filed: May 22, 2007
(86) PCT No.: PCT/KR2007/002475

§ 371 Date: Sep. 11, 2008

(30) Foreign Application Priority Data
May 22, 2006 (KR) 10-2006-0045763
May 22, 2006 (KR) 10-2006-0045769

(51) Int. Cl. H04L 27/00

(52) U.S. Cl. 375/316

(57) ABSTRACT

A portable terminal having a function for automatically searching for a broadcasting channel, which may automatically set the broadcasting channel according to variation of a broadcasting zone, and a method of automatically searching for a broadcasting channel in a portable terminal are disclosed. A wireless transceiver receives a system information from a base station, and a controller obtains a receivable broadcasting channel based on the system information. Accordingly, the broadcasting channel may be automatically searched based on the location of the portable terminal, and users desired broadcasting channel may be represented.

### TECHNICAL FIELD

The present invention relates to a portable terminal, and more particularly relates to a portable terminal, which has DMB (Digital Multimedia Broadcasting) receiving function, having an automatic broadcasting channel searching function and methods of searching broadcasting channels automatically in the portable terminal.

### BACKGROUND ART

Recently, the terrestrial digital multimedia broadcasting (hereinafter, referred to as “DMB”) service begins so that a user may receive various digital broadcasting on the roads using a portable device such as mobile communication device, DMB receiver, PDA (Personal Digital Assistants), etc.

The terrestrial DMB service provides TV programs, radio programs and SMS (Short Message Service) while the user moves using digital broadcasting technology. The terrestrial DMB service also provides audio having CD-quality and data services or image services, etc. That is, the terrestrial DMB service is a multimedia mobile broadcasting service, in which digital communication and broadcasting are converged, that is provided with a good quality of mobile TV program and TV program.

The terrestrial broadcasting network for the terrestrial DMB service uses a single frequency network for all regions but the terrestrial broadcasting network uses multi frequency network so as to prevent interference due to single frequency network. That is, different frequency is used depending upon the broadcasting zone.

Accordingly, when a portable terminal, in which a receivable broadcasting channel is set for a specific broadcasting zone, moves from a broadcasting zone to other broadcasting zone, the pre-set broadcasting channel may be not received due to the variation of the frequency.

When the conventional portable terminal moves from a current broadcasting zone, to which an active broadcasting channel is set, to other broadcasting zone, the user has to manually execute the function for setting the broadcasting channel to set the broadcasting channel again. Further, whenever the broadcasting zone is changed, the user has to repeatedly set an active broadcasting channel. As a result, it is inconvenient to use the conventional portable terminal.

### DISCLOSURE OF INVENTION

### Technical Problem

It is a first object of the present invention to provide a portable terminal, which has an automatic search function for broadcasting channel, capable of automatically setting the broadcasting channel according to variation of broadcasting zone.

It is a second object of the present invention to provide a method of automatically searching for broadcasting channel in a portable terminal, in which the broadcasting channel may be automatically set according to variation of a broadcasting area.

### Technical Solution

A portable terminal having a function for receiving a digital broadcasting and having a function for automatically searching for a broadcasting channel according to an aspect of the present invention for the purpose of the first object of the present invention includes a wireless transceiver configured to receive a system information from a base station and a controller configured to obtain a receivable broadcasting channel based on the system information. The controller may obtain a location information of the portable terminal based on the system information, and may obtain a broadcasting channel corresponding to the obtained location information. The portable terminal may further include a memory configured to store the location information of the portable terminal and the broadcasting channel corresponding to the location information. The controller may obtain the location information of the portable terminal based on the system information, and may read the broadcasting channel corresponding to the obtained location information from the memory. When the broadcasting channel corresponding to the location information doesn't exist in the memory, the controller may search a receivable broadcasting channel in a current location of the portable terminal, and may store the searched broadcasting channel and the location information in the memory. The controller may obtain the receivable broadcasting channel using a service information included in the received broadcasting signal. The controller may sort the broadcasting channel read from the memory based on a number of times for watching a broadcasting channel to represent the sorted broadcasting channel. The controller may sort the broadcasting channel read from the memory based on receive sensitivity to represent the sorted broadcasting channel. The location information may be obtained based on an SID (system identification) and an NID (network identification) information of the system information. The portable terminal may further include a broadcast receiver configured to receive a broadcasting signal and a service information included in the received broadcasting signal. The controller may obtain the location information of the portable terminal based on the system information, obtains a broadcasting zone where the portable terminal belongs based on the obtained location information and may obtain a broadcasting channel corresponding to the obtained broadcasting zone. The location information may be obtained based on an SID (system identification) and an NID (network identification) information of the system information. The portable terminal may further include a memory configured to store the location information of the portable terminal, the broadcasting zone corresponding to the location information and the broadcasting channel corresponding to the broadcasting zone. When the broadcasting channel corresponding to the obtained broadcasting zone doesn't exist in the memory, the controller may search the receivable broadcasting channel in the broadcasting zone where the portable terminal belongs, and stores the searched broadcasting channel in the memory.

A portable terminal having a function for receiving a digital broadcasting and having a function for automatically searching for a broadcasting channel according to another aspect of the present invention for the purpose of the first object of the present invention includes a GPS receiver configured to calculate a location of the portable terminal based on a GPS signal, a controller configured to obtain a receivable broadcasting channel based on the location of the portable terminal. The controller may obtain a broadcasting zone where the portable terminal belongs based on the location of the portable terminal, and may obtain a broadcasting channel corresponding to the obtained broadcasting zone.

The portable terminal may further include a memory configured to store a receivable broadcasting channel by each of broadcasting zones. When a broadcasting channel corresponding to the obtained broadcasting zone doesn't exist in the memory, the controller may search a receivable broadcasting channel in the broadcasting zone where the portable terminal belongs, and stores the searched broadcasting channel in the memory. The controller may obtain the receivable broadcasting channel using a service information included in the received broadcasting signal. The controller may sort the broadcasting channel read from the memory based on a number of times for watching a broadcasting channel to represent the sorted broadcasting channel. The controller may sort the broadcasting channel read from the memory based on receive sensitivity to represent the sorted broadcasting channel. The portable terminal may further include a broadcast receiver configured to receive a broadcasting signal and a service information included in the received broadcasting signal.

A method of automatically searching for a broadcasting channel in a portable terminal having a function for receiving a digital broadcasting according to an aspect of the present invention for the purpose of the second object of the present invention includes receiving a system information from a base station, and obtaining a receivable broadcasting channel based on the system information. The obtaining a receivable broadcasting channel based on the system information may include obtaining a location information of the portable terminal based on the system information, and reading a broadcasting channel corresponding to the obtained location information from a database. The obtaining a receivable broadcasting channel based on the system information may further include representing the broadcasting channel read from the database.

The location information may be obtained based on an SID (system identification) and an NID (network identification) information of the system information. The obtaining a receivable broadcasting channel based on the system information may further include searching a receivable broadcasting channel in a current location of the portable terminal, and storing the searched broadcasting channel and the location information in the memory when the broadcasting channel corresponding to the location information doesn't exist in the memory. The obtaining a receivable broadcasting channel based on the system information may further include: obtaining the location information of the portable terminal from the received system information, obtaining the broadcasting zone corresponding to the obtained location information, and reading the broadcasting channel corresponding to the obtained broadcasting zone from the database. The obtaining a receivable broadcasting channel based on the system information may further include representing the broadcasting channel read from the database. the location information is obtained based on an SID (system identification) and an NID (network identification) information of the system information. The obtaining a receivable broadcasting channel based on the system information may further include searching the receivable broadcasting channel in the broadcasting zone where the portable terminal belongs, and storing the searched broadcasting channel in the memory when the broadcasting channel corresponding to the broadcasting zone doesn't exist in the memory.

A method of automatically searching for a broadcasting channel in a portable terminal having a function for receiving a digital broadcasting according to another aspect of the present invention for the purpose of the second object of the present invention includes calculating a location of a portable terminal, and obtaining a receivable broadcasting channel based on the calculated location. The calculating a location of a portable terminal may include calculating the location of the portable terminal based on a GPS (Global Positioning System) signal. The obtaining a receivable broadcasting channel based on the calculated location may include obtaining a broadcasting zone of the portable terminal based on the calculated location, and reading the receivable broadcasting channel from a database. The obtaining a receivable broadcasting channel based on the calculated location may further include searching the receivable broadcasting channel, and storing the searched broadcasting channel in the database when the broadcasting channel corresponding to the calculated broadcasting zone doesn't exist in the database. The searching the receivable broadcasting channel, and storing the searched broadcasting channel in the database when the broadcasting channel corresponding to the calculated broadcasting zone doesn't exist in the database may include searching the receivable broadcasting channel using a service information included in the received broadcasting signal. The obtaining a receivable broadcasting channel based on the calculated location may further include sorting the broadcasting channels read from the database based on a number of times for watching the broadcasting channel, and representing the sorted broadcasting channels. The obtaining a receivable broadcasting channel based on the calculated location may further include sorting the broadcasting channels read from the database based on receive sensitivity, and representing the sorted broadcasting channels.

### BRIEF DESCRIPTION OF THE DRAWINGS

FIG. 1 is a block diagram illustrating a potable terminal having an automatic searching function for broadcasting channels according to one example embodiment of the present invention.

FIG. 2 is a flowchart illustrating an automatic search process for broadcasting channels in a portable terminal according to one example embodiment of the present invention.

FIG. 3 is a flowchart illustrating an automatic search process in a portable terminal according to another example embodiment of the present invention.

FIG. 4 is a block diagram illustrating a portable terminal having an automatic searching function for broadcasting channels according to another example embodiment of the present invention.

FIG. 5 is a flowchart illustrating an automatic search process for broadcasting channels in the portable terminal shown in FIG. 4 according to another example embodiment of the present invention.

FIG. 6 is a block diagram illustrating a portable terminal having an automatic search function for broadcasting channels according to still another example embodiment of the present invention.

FIG. 7 is a flowchart illustrating an automatic search process in a portable terminal according to still another example embodiment of the present invention.

FIG. 8 is a flowchart illustrating an automatic search process in a portable terminal according to still another example embodiment of the present invention.

FIG. 9 is a block diagram illustrating a user interface which supports an automatic search for broadcasting channels in a portable terminal according to still another example embodiment of the present invention.

### MODE FOR THE INVENTION

Example embodiments of the present invention are disclosed herein. Although embodiments have been described with reference to a number of illustrative embodiments thereof, it should be understood that numerous other modifications and embodiments can be devised by those skilled in the art that will fall within the spirit and scope of the principles of this disclosure. While the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more other features, integers, steps, operations, elements, components, and/or groups thereof.

Example embodiments of the present invention are disclosed herein.

Like numbers refer to like elements throughout the description of the figures.

Hereinafter, a broadcasting includes a terrestrial digital TV broadcasting. Namely, a broadcasting includes a terrestrial DMB and a European DVB (Digital Video Broadcasting).

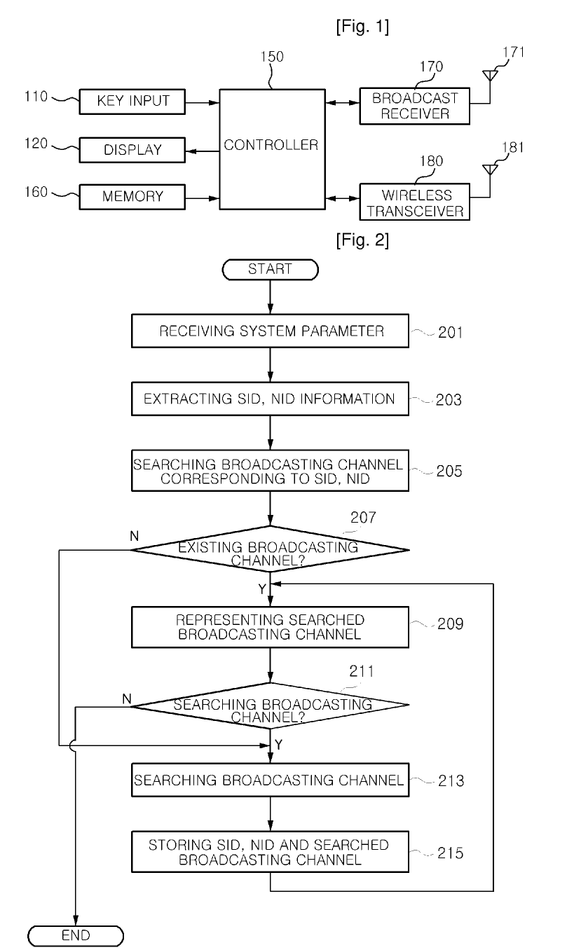

FIG. 1 is a block diagram illustrating a potable terminal having an automatic searching function for broadcasting channels according to one example embodiment of the present invention.

Referring to FIG. 1, the portable terminal includes a key input 110, a display 120, a controller 150, a memory 160, a broadcast receiver 170 and a wireless transceiver 180.

The key input 110 includes a plurality of characteristic keys, numeric keys and function keys for performing specific functions. The key input 110 transmits a key event signal corresponding to a key selection by a user to the controller 150. The key input 110 transmits a key event signal corresponding to a key selection when the user presses a key which designates set/cancel of an automatic search for broadcasting channels, a search for broadcasting channels and a selection of a broadcasting channel.

The display 120 includes an LCD (Liquid Crystal Display) or an OLED (Organic Light Emitting Diodes). The display 120 displays a user interface such as menus, execution image of various application programs or broadcasting images.

The display 120 represents the user interface such as the set/cancel of the automatic search for the broadcasting channels, broadcasting zones, channel lists, channel searches, etc. When the automatic search function of the broadcasting channels is set, the display 120 receives available broadcasting channel lists from the controller 150 and represents the received broadcasting channel lists on a screen.

When the automatic search function for the broadcasting channels is enabled, the controller 150 receives system information from a base station through the wireless transceiver 180, and then extracts network information from the system information.

The system information may include a system parameter message. The network information may include SID (System Identification) information and NID (Network Identification) information.

For example, the controller 150 receives the system parameter message from the base station, and extracts the SID and NID information from the received system parameter message.

In detail, when power voltage is supplied to the portable terminal, the portable terminal is initialized and enters into an idle state after the initialization process is finished. The initialization process includes booting the portable terminal, receiving pilot channel, and extracting the system information from sync channel. The idle state means that the portable terminal receives paging channel message continuously after the portable terminal receives all of the system information and finishes normal operations.

The paging channel message represents an overhead message, which has the important system information and is basically received by all portable terminals. The overhead message is classified to a configuration message and an access message, and the configuration message includes the system parameter message.

The system parameter message includes the SID, NID, base station information and designated values for each of the sectors of the base station. The SID information includes a system number, that is, the system number is used for distinguishing between different mobile network operators and may be composed of 15 bits. The NID information is a subordinate of the SID information, and includes a number for distinguishing between a plurality of MSC (Mobile Switching Center) of the different mobile network operators, and the NID information may be composed of 16 bits.

The portable terminal according to an example embodiment of the present invention uses the SID and NID information included in the system parameter message as the network information for which the portable terminal automatically searches the receivable broadcasting channels in a current area (that is, a predetermined broadcasting zone).

However, when the portable terminal is roaming automatically or manually in the mobile communication environment where various mobile communication networks such as CDMA (Code Division Multiple Access), PCS (Personal Communication Service), AMPS (Advanced Mobile Phone Service), etc. coexist, other network information may be used instead of the SID and NID information.

The controller 150 extracts the SID and NID information from the system parameter message, searches the broadcasting channel corresponding to the extracted SID and NID information and represents the searched broadcasting channel list through the display 120.

When the broadcasting channel corresponding to the SID and NID information is not found from a database, the controller 150 extracts the broadcasting channel from a service information received through the broadcast receiver 170, searches receivable broadcasting channel, stores the searched broadcasting channels in association with the SID and NID information into the database, and at the same time, displays the searched broadcasting channel lists through the display 120. The service information is included in an EPG (Electronic Program Guide) and includes the receivable broadcasting channels.

The controller 150, according to another example embodiment of the present invention, sorts the searched broadcasting channels based on priority, displays the sorted broadcasting channels on the display 120 so that the user may easily select the desired broadcasting channel.

For example of priority, whenever the user watches a specific broadcasting channel, the controller 150 stores the information, which relates with the number of time of watching the specific broadcasting channel and the hour of watching the specific broadcasting channel, in database for each of the broadcasting channels. When a key event signal which request for watching broadcasting is received, the controller 150 displays the broadcasting channel, which is most popular at current time, on the top of the display 120 so that the user may easily select the favorite broadcasting channel only by simple key operation.

Additionally, the controller 150 stores the searched broadcasting channels and receive sensitivity corresponding to each of the searched broadcasting channels, and the controller 150 may display broadcasting channels in the order of the highest receiving sensitivity on the display 120.

The memory 160 may include at least one of the flash memory, RAM (Random Access Memory) and EEPROM (Electrically Erasable and Programmable Read Only Memory). The memory 160 stores the SID and NID information, and the broadcasting channel information corresponding to the SID and NID information, which are received from the controller 150, in database form.

The memory 160 may store the watching hour and/or the number of watching, the receive sensitivity of each of the broadcasting channels in addition to the SID and NID information, and the broadcasting channel information corresponding to the SID and NID information.

The broadcast receiver 170 receives broadcasting signals, and receives the service information included in the received broadcasting signals. The broadcast receiver 170 corresponds to the prior art. Accordingly, the broadcast receiver 170 is not illustrated in detail. The broadcast receiver 170 may include an antenna 171, a tuner (not shown) and a demodulator (not shown). The tuner extracts a frequency signal, which corresponds to the broadcasting channel selected in response to a channel selection signal provided from the controller 150, from a radio frequency signal received through the antenna 171.

The demodulator receives the frequency signal corresponding to the broadcasting channel selected by the tuner, demodulated the received frequency signal and provides the service information to the controller 150 so that the controller 150 may search the receivable broadcasting channels in the current broadcasting zone.

Additionally, the broadcast receiver 170 decodes each of video signals, audio signals and data signals included in the broadcasting signals received through the antenna 171, and provides the decoded signals to the controller 150.

The wireless transceiver 180 converts the radio frequency signals received through an antenna 181 into baseband signals, and provides the baseband signals to the controller 150. The wireless transceiver 180 converts the baseband signals into the radio frequency signals to output the converted radio frequency signals through the antenna 181.

As shown in FIG. 1, although the wireless transceiver 180 and the controller 150 are illustrated in a separate block, in another example embodiment of the present invention, the wireless transceiver 180 and the controller 150 may be implemented by a single block or one chip. As shown in FIG. 1, although the wireless transceiver 180, the broadcast receiver 170 and the controller 150 are illustrated in a separate block, in another example embodiment of the present invention, the wireless transceiver 180, the broadcast receiver 170 and the controller may be implemented by one block or one chip.

FIG. 2 is a flowchart illustrating an automatic search process for a broadcasting channel of a portable terminal according to one example embodiment of the present invention. It is assumed that the portable terminal may continuously receive a system parameter message from a base station through a paging channel after the portable terminal is initialized.

Referring to FIG. 2, the controller 150 receives the system parameter message from the base station through the wireless transceiver 180 (step 201), and extracts network information from the received system parameter message (step 203).

For example, the network information may include SID and NID information included in the system parameter message. However, when the portable terminal is roaming automatically or manually in the mobile communication environment where various mobile communication networks such as CDMA (Code Division Multiple Access), PCS (Personal Communication Service), AMPS (Advanced Mobile Phone Service), etc. coexist, other network information may be used instead of the SID and NID information.

The controller 150 searches the broadcasting channel corresponding to the extracted SID and NID information from a database of the memory 160 (step 205), and determines whether the broadcasting channel corresponding to the network information such as the extracted SID and NID information is stored in the database (step 207).

The controller 150 represents the searched broadcasting channels through the display 120 when the broadcasting channel corresponding to the SID and NID information is stored in the database (step 209).

The controller 150 determines whether or not a key event signal which requests a search for the broadcasting channel is received from the key input 110 (step 211), and when the key event signal which requests the search for the broadcasting channel is received, the controller 150 searches receivable broadcasting channels in the current area of the portable terminal based on the service information received from the broadcast receiver 170 (step 213).

The controller 150 stores the searched broadcasting channels in association with the network information such as the SID and NID information which are extracted in the step S203, and the associated SID and NID information in the database of the memory 160 (step 215)

The search process for the broadcasting channel performed at the step 213 is performed after the broadcasting channel corresponding to the network information such as the extracted SID and NID information is represented on the display 120. Accordingly, the search process for the broadcasting channel performed at the step 213 means that the user repeatedly searches the receivable broadcasting channels in the current area.

After the determining step 207, when the broadcasting channel corresponding to the network information such as the extracted SID and NID information does not exist in the database, the controller 150 goes to the step 213 to search the broadcasting channel.

After the determining step 211, when the key event signal which requests the search for the broadcasting channels is not received from the key input 110, it means that the user doesn't want anymore to repeatedly search the broadcasting channel. Accordingly, the automatic search process for the broadcasting channel of the portable terminal is finished.

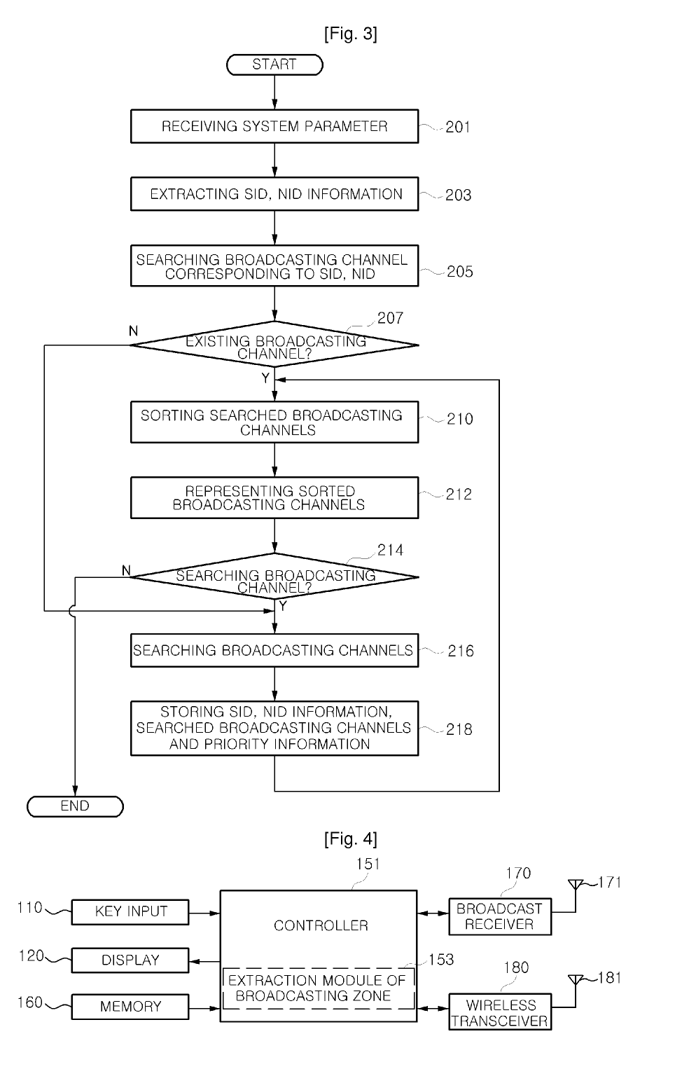

FIG. 3 is a flowchart illustrating an automatic search process of a portable terminal according to another example embodiment of the present invention. Because steps 201 through 207 are identical with those of FIG. 2, detailed descriptions for each step 201 through S 207 are omitted.

After the determining step 207, when the broadcasting channel corresponding to the network information such as the extracted SID and NID information exist in the database, the controller 150 sorts the searched broadcasting channels based on priority (step 210). The network information may include the SID and NID information included in the system parameter message.

However, when the portable terminal is roamed automatically or manually in the mobile communication environment where various mobile communication networks such as CDMA (Code Division Multiple Access), PCS (Personal Communication Service), AMPS (Advanced Mobile Phone Service), etc. coexist, other network information may be used instead of the SID and NID information.

For example, the priority may include the number of time for watching each of the broadcasting channels or the receive sensitivity of each of the broadcasting channels. Additionally, the priority may be determined based on both of the number of time for watching each of the broadcasting channels and the receive sensitivity. In detail, the priory may be determined by multiplying some weights by each of the number of time for watching each of the broadcasting channels and the receive sensitivity.

The controller 150 represents the sorted broadcasting channel list based on the priority so that the user may easily select a desired broadcasting channel to watch the desired broadcasting channel (step 212).

The controller 150 determines whether or not the key event signal, which requests the search for the broadcasting channels, is received from the key input 110 (step 214), and when the key event signal is received from the key input 110, the controller 150 searches the receivable broadcasting channel based on the service information received from the broadcast receiver 170 (step 216).

The controller 150 stores the network information such as the SID and NID information extracted from the step 203, the searched broadcasting channels and the priority information related with the broadcasting channels in the database of the memory 160 (step 218), and the controller 150 goes back to the step 210 to sort the searched broadcasting channel based on the priority and sequentially performs next steps.

For example, when the receive sensitivity of the broadcasting channel is set for the priority, the controller 150 searches the receivable broadcasting channel in the current area of the portable terminal, and stores both the searched broadcasting channels and the receive sensitivity of each broadcasting channel in the database.

When the broadcasting channels are represented on the display 120, the broadcasting channels are sorted in order of the receive sensitivity, the broadcasting channels sorted in order of the receive sensitivity are displayed. Accordingly, the user may select the broadcasting channel having the better receive sensitivity preferentially.

The controller 150 searches the broadcasting channel corresponding to the network information such as the SID and NID information from the database in the memory 160, and sorts the searched broadcasting channels based on the predetermined priority to represent the sorted broadcasting channels on the display 120. Accordingly, the user may easily select the desired broadcasting channel.

After the broadcasting channels are represented on the display 120, when the search process for the broadcasting channel is performed by the user, the controller 150 searches the broadcasting channel to store the network information such as the SID and NID information, the searched broadcasting channels and the priority information in the database in association with one another. As a result, the controller 150 updates the database to represent the updated data on the display 120.

After the determining step 207, when the broadcasting channel corresponding to the network information such as the SID and NID information does not exist in the database, the controller 150 goes back to the step 216 to search the receivable broadcasting channel.

After the determining step 214, when the key event signal, which requests the search for the broadcasting channel is not received from the key input 110, the controller 150 decides that the user does not repeatedly search the broadcasting channel, and finishes the automatic search process for the broadcasting channel of the portable terminal.

FIG. 4 is a block diagram illustrating a portable terminal having an automatic searching function for broadcasting channels according to another example embodiment of the present invention.

Referring to FIG. 4, the portable terminal, according to another example embodiment of the present invention, includes a key input 110, a display 120, a controller 151, a memory 160, a broadcast receiver 170 and a wireless transceiver 180. Because the key input 110, the display 120, the broadcast receiver 170 and the wireless transceiver 180 perform the identical functions to that of the elements having identical reference number shown in FIG. 1, detailed descriptions on the key input 110, the display 120, the broadcast receiver 170 and the wireless transceiver 180 are omitted.

The controller 151 includes an extraction module 153 of a broadcasting zone. When an automatic search function for the broadcasting channels is enabled, the controller 151 receives a system parameter message from a base station through the wireless transceiver 180 to extract network information (for example, SID and NID information) from the received system parameter message. The network information may be the SID and NID information included in the system parameter message.

However, when the portable terminal is roaming automatically or manually in the mobile communication environment where various mobile communication networks such as CDMA (Code Division Multiple Access), PCS (Personal Communication Service), AMPS (Advanced Mobile Phone Service), etc. coexist, other network information may be used instead of the SID and NID information.

The extraction module 153 of the broadcasting zone reads the broadcasting zone corresponding to the network information such as the extracted SID and NID information from the memory 160. The broadcasting zone information, corresponding to the network information such as the SID and NID information, may be previously stored in the memory 160.

The controller 151 determines whether the broadcasting channel corresponding to the broadcasting zone extracted from the extraction module 153 exists in a database of the memory 160. When the broadcasting channel corresponding to the broadcasting zone extracted from the extraction module 153 exists in the database of the memory 160, the controller 151 reads the broadcasting channel from the database of the memory 160 to represent the broadcasting channel read from the database on the display 120.

When the broadcasting channel corresponding to the extracted broadcasting zone doesn't exist in the database of the memory 160, the controller 151 extracts the broadcasting channel information from the service information received through the broadcast receiver 170 to search the receivable broadcasting channels. The controller 151 stores the searched broadcasting channels in the database of the memory 160, and at the same time, represents the searched broadcasting channels on the display 120.

The memory 160 may include at least one of the flash memory, RAM (Random Access Memory) and EEPROM (Electrically Erasable and Programmable Read Only Memory). The memory 160 stores the network information such as the SID and NID information, and the broadcasting zone information corresponding to the network information. In addition, the memory 160 may store the broadcasting zone and the receivable broadcasting channels in each of the broadcasting zones.

As shown in FIG. 4, although the wireless transceiver 180 and the controller 151 are illustrated in a separate block, in another example embodiment of the present invention, the wireless transceiver 180 and the controller 151 may be implemented by a single block or one chip. As shown in FIG. 4, although the wireless transceiver 180, the broadcast receiver 170 and the controller 151 are illustrated in a separate block, in another example embodiment of the present invention, the wireless transceiver 180, the broadcast receiver 170 and the controller 151 may be implemented by one block or one chip.

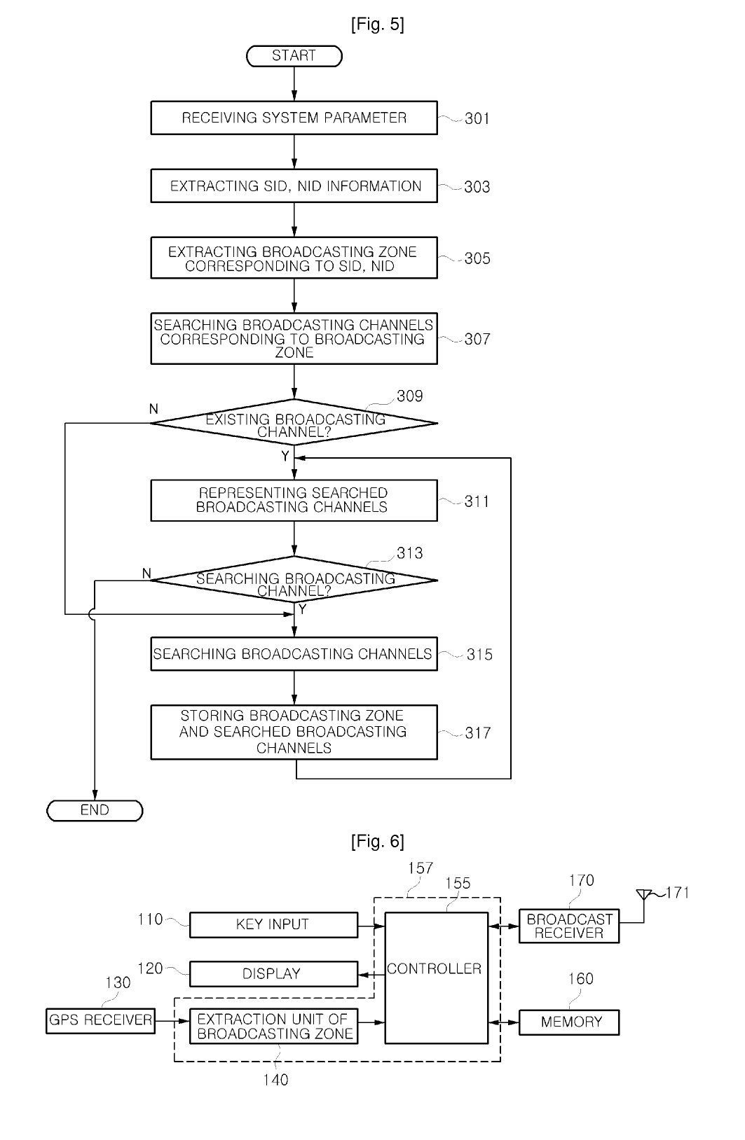

FIG. 5 is a flowchart illustrating an automatic search process for a broadcasting channel of the portable terminal shown in FIG. 4 according to another example embodiment of the present invention. It is assumed that the portable terminal may continuously receive a system parameter message from a base station through a paging channel after the portable terminal is initialized.

Referring to FIG. 5, the controller 151 receives a system parameter message from a base station through the wireless transceiver 180 (step 301), and extracts network information from the received system parameter message (step 303).

The network information may be the SID and NID information included in the system parameter message. However, when the portable terminal is roaming automatically or manually in the mobile communication environment where various mobile communication networks such as CDMA (Code Division Multiple Access), PCS (Personal Communication Service), AMPS (Advanced Mobile Phone Service), etc. coexist, other network information may be used instead of the SID and NID information.

The controller 151 reads out the broadcasting zone corresponding to the network information such as the extracted SID and NID information from the memory 160 to extract the broadcasting zone corresponding to the current area of the portable terminal (step 305).

The controller 151 searches the broadcasting channel corresponding to the extracted broadcasting zone from the database of the memory 160 (step 307), and determines whether the broadcasting channel corresponding to the broadcasting zone exists in the database (step 309).

When the broadcasting channel corresponding to the extracted broadcasting zone exists, the controller 151 represents the searched broadcasting channels on the display 120 (step 311).

The controller 151 determines whether or not the key event signal, which requests the search for the broadcasting channel, is received from the key input 110 (step 313), and when the key event signal corresponding to the search for the broadcasting channel is received, the controller 151 searches the receivable broadcasting channels in the broadcasting zone where the portable terminal is currently located based on the service information received through the broadcast receiver 170 (step 315).

The controller 151 stores the extracted broadcasting zone and the searched broadcasting channel in association with each other into the database to update the database (step 317), and the controller 151 goes back to the step 311 to represent the searched broadcasting channel on display 120. The next steps of the step 311 are sequentially performed.

After the determining step 309, when the broadcasting channel corresponding to the broadcasting zone where the portable terminal is currently located doesn't exist, the controller 151 proceeds to the step 315 to search the receivable broadcasting channel in the current broadcasting zone, and the controller 151 performs the next steps sequentially.

After the determining step 313, when the key event signal, which requests the search for the broadcasting channel, is not received from the key input 110, the controller decides that the user does not repeatedly search the broadcasting channel. Accordingly, the controller 151 finishes the automatic search process for the broadcasting channels of the portable terminal.

FIG. 6 is a block diagram illustrating a portable terminal having an automatic search function of broadcasting channels according to still another example embodiment of the present invention.

Referring to FIG. 6, the portable terminal according to still another example embodiment of the present invention includes a key input 110, a display 120, a GPS receiver 130, an extraction unit of a broadcasting zone 140, a controller 155, a memory 160 and a broadcast receiver 170.

The key input 110, the display 120 and the broadcast receiver 170 perform identical functions to that of the elements having identical reference number shown in FIG. 1. Accordingly, detailed descriptions on the key input 10, the display 120 and the broadcast receiver 170 are omitted.

The GPS (Global Positioning System) receiver 130 processes GPS signals received from several satellites to calculate a location, a velocity and a time of the portable terminal, and provides the current location of the portable terminal to the extraction unit of the broadcasting zone 140.

The extraction unit of the broadcasting zone 140 receives the current location of the portable terminal from the GPS receiver 130, and extracts a broadcasting zone where the portable terminal belongs from the provided current location of the portable terminal to provide the extracted broadcasting zone to the controller 155.

When the automatic search process for the broadcasting channel is enabled, the controller 155 receives the broadcasting zone where the portable terminal belongs from the extraction unit of the broadcasting zone 140. And then, the controller 155 reads the broadcasting channel corresponding to the provided broadcasting zone from the database of the memory 160 to represent the read broadcasting channel on the display 120.

When the broadcasting channel corresponding to the broadcasting zone where the portable terminal currently belongs doesn't exist in the database, the controller 155 extracts the broadcasting channel information from the service information received through the broadcast receiver 170 to search the receivable broadcasting channel in the current broadcasting zone. And then, the controller 155 stores the searched broadcasting channel in the database of the memory 160 and at the same time, represents the searched broadcasting channel on the display 120.

In FIG. 6, the extraction unit of the broadcasting zone 140 and the controller 155 are illustrated in a separate block, however, in still another example embodiment of the present invention, the extraction unit of the broadcasting zone 140 and the controller 155 may be implemented by one block 157 or one chip. Alternatively, in still another example embodiment of the present invention, the GPS receiver 130, the extraction unit of the broadcasting zone 140 and the controller 155 may be implemented by one block 157 or one chip.

The memory 160 stores the broadcasting channels available according to the broadcasting zones in database form. Further, the memory 160 may store user s watching hour and/or the number of times for watching each of the broadcasting channels in addition to the broadcasting channels corresponding to the broadcasting zones.

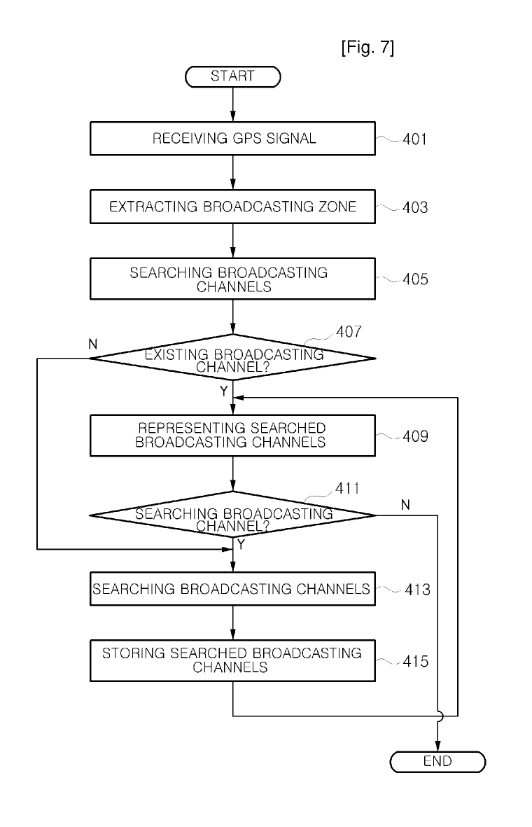

FIG. 7 is a flowchart illustrating an automatic search process of a portable terminal according to still another example embodiment of the present invention. It is assumed that the portable terminal is initialized, and the serviceable broadcasting channels according to the broadcasting zones are stored in the database of the memory 160.

Referring to FIG. 7, the GPS receiver 130 calculates the current location of the portable terminal based on the GPS signal received from the satellite (step 401), and provides the calculated current location of the portable terminal to the extraction unit of the broadcasting zone 140.

The extraction unit of the broadcasting zone 140 receives the current location of the portable terminal from the GPS receiver 130, and extracts the broadcasting zone where the portable terminal currently belongs based on the received current location to provide the extracted broadcasting zone to the controller 155 (step 403).

The controller 155 receives the broadcasting zone where the portable terminal currently belongs from the extraction unit 140 of the broadcasting zone, and searches the database of the memory 160 to read the broadcasting channel corresponding to the received broadcasting zone from the database (step 405).

Afterwards, the controller 155 determines whether or not the broadcasting channel corresponding to the current broadcasting zone exists (step 407), and when the broadcasting channel exists, the controller 155 represents the broadcasting channel, which is searched from the database, corresponding to the current broadcasting zone on the display 120 (step 409).

Next, the controller 155 determines whether or not the key event signal, which requests the search for the broadcasting channel. is received from the key input 110 (step 411), and when the key event signal is received, the controller 155 searches the receivable broadcasting channel in the current broadcasting zone based on the service information provided from the broadcast receiver 170 (step 413).

The controller 155 stores the searched broadcasting channel in the database of the memory 160 (step 415), and goes back to the step 409 to represent the searched broadcasting channel on the display 120. And then, the next steps are sequentially performed.

The controller 155 searches the receivable broadcasting channels in the broadcasting zone where the portable terminal is currently located from the database of the memory 160 to represent the searched broadcasting channel on the display 120. As a result, the user may easily select a desired broadcasting channel to watch the desired broadcasting channel. After the broadcasting channel is represented on the display 120, when the user repeatedly searches the broadcasting channels, the controller 155 searches the receivable broadcasting channels in the broadcasting zone where the portable terminal is currently located. And then, the controller 155 stores the searched broadcasting channels in the database to update the database, at the same time, represents the searched broadcasting channels on the display 120.

After the determining step 407, when the broadcasting channel corresponding to the broadcasting zone where the portable terminal is currently located doesn't exist in the database, the controller 155 proceeds to the step 413 to search the receivable broadcasting channels in the current broadcasting zone.

In the step 411, when the key event signal, which requests the search for the broadcasting channels, is not received from the key input 110, it means that the user doesn't want anymore to repeatedly search the broadcasting channels. Accordingly, the automatic search process for the broadcasting channels is finished.

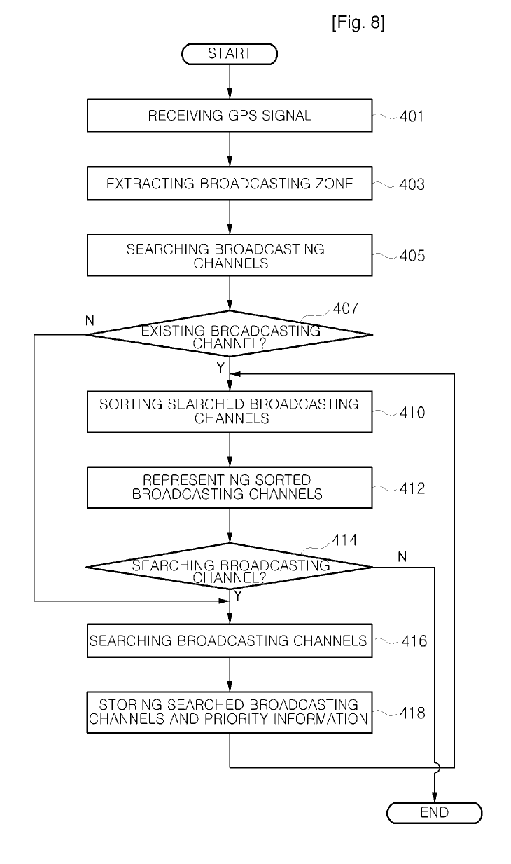

FIG. 8 is a flowchart illustrating an automatic search process of a portable terminal according to still another example embodiment of the present invention. Steps 401 through 407 are identical with those shown in FIG. 7. Accordingly, detailed descriptions on the steps 401 through 407 shown in FIG. 8 are omitted to avoid repetition.

After the determining step 407, when the broadcasting channel corresponding to the current broadcasting zone exist in the database, the controller 155 sorts the searched broadcasting channels based on priority (step 410). The priority may include the number of times for watching each of the broadcasting channels or receive sensitivity for each of the broadcasting channels. Alternatively, the priority may be determined by considering both of the number of times for watching each of the broadcasting channels and the receive sensitivity for each of the broadcasting channels. In detail, the priority may be determined by multiplying some weights by each of the number of times for watching each of the broadcasting channels and the receive sensitivity for each of the broadcasting channels.

The controller 155 represents the sorted broadcasting channel list based on the priority on the display 120 so that the user may easily select a desired broadcasting channel (step 412).

The controller 155 determines whether or not the key event signal, which requests the search for the broadcasting channel, is received from the key input 110 (step 414), and when the key event signal is received from the key input 110, the controller 155 searches the receivable broadcasting channels in the current broadcasting zone based on the service information received from the broadcast receiver 170 (step 416).

The controller 155 stores the searched broadcasting channels and the priority information related with the searched broadcasting channels in the database of the memory 160 (step 418), and the controller 155 goes back to the step 410 to sort the searched broadcasting channels based on the priority and next steps are sequentially performed.

For example, when the receive sensitivity of the broadcasting channel is set for the priority, the controller 155 searches the receivable broadcasting channels in the current broadcasting zone to which the portable terminal belongs, and stores both the searched broadcasting channels and the receive sensitivity of each of the broadcasting channels in the database.

When the broadcasting channels are represented on the display 120, the broadcasting channels are sorted in order of the receive sensitivity to represent the broadcasting channels sorted in order of the receive sensitivity. Accordingly, the user may select the broadcasting channel having the better receive sensitivity preferentially.

The controller 155 searches the receivable broadcasting channels in the broadcasting zone where the portable terminal is currently located from the database in the memory 160, and sorts the searched broadcasting channels based on the predetermined priority to represent the sorted broadcasting channels on the display 120. Accordingly, the user may easily select the desired broadcasting channel.

After the broadcasting channels are represented on the display 120 and the search process for the broadcasting channel is performed by the user, the controller 155 searches the broadcasting channels again to store the searched broadcasting channels and the priority information in the database in association with each other. And then, the controller 155 updates the database and at the same time, represents the updated data on the display 120.

After the determining step 407, when the broadcasting channel corresponding to the broadcasting zone where the portable terminal is currently located doesn't exist in the database, the controller 155 proceeds to the step 416, and searches the receivable broadcasting channels in the current broadcasting zone.

In the step 414 when the key event signal, which requests the search for the broadcasting channel, is not received from the key input 110, it means that the user doesn't want anymore to repeatedly search the broadcasting channels. Accordingly, the controller 155 finishes the automatic search process for the broadcasting channel of the portable terminal.

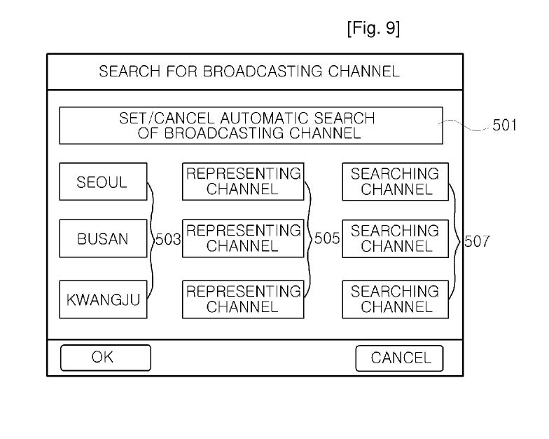

FIG. 9 is a block diagram illustrating a user interface which supports an automatic search for a broadcasting channel of a portable terminal according to still another example embodiment of the present invention.

Referring to FIG. 9, the portable terminal according to an example embodiment of the present invention provides a setting/cancel menu 501 for the automatic search of the broadcasting channel through the display 120 so that the user may enable or disable the automatic search function of the broadcasting channel.

When the automatic search function of the broadcasting channel is enabled by the user, the receivable broadcasting channels in the broadcasting zone where the portable terminal is currently located are automatically searched. And then, the searched broadcasting channels are represented on the display 120.

Additionally, a menu 503 for representing broadcasting zones, a menu 505 for representing channel and a menu 507 for representing channel search are provided so that the user directly verifies the receivable broadcasting channels to search the broadcasting channels.

For example, when the portable terminal according to an example embodiment of the present invention is currently located in Seoul, the user may select ‘Seoul’ in the menu 503 for representing the broadcasting zones, executes the menu 505 for representing the channel, verifies the receivable broadcasting channels in Seoul which are stored in the database of the memory 160, and executes the menu 507 for representing the channel search to search again the receivable broadcasting channels in Seoul.

### INDUSTRIAL APPLICABILITY

According to the portable terminal having the automatic search function for the broadcasting channel and the method of automatically searching for the broadcasting channel of the portable terminal, the current location of the portable terminal is determined based on the system information received from the base station or the GPS signal received from the satellite. The broadcasting channel information corresponding to the current location of the portable terminal is read from the database. And then, the read broadcasting channel is displayed. Additionally, the portable terminal sorts the broadcasting channels based on the predetermined priority to represent the sorted broadcasting channels.

Accordingly, the broadcasting channels may be automatically searched based on the current location of the portable terminal, and the user s desired broadcasting channel may be displayed.

1. A portable terminal having a function for receiving a digital broadcasting and having a function for automatically searching for a broadcasting channel, the portable terminal comprising:
a wireless transceiver configured to receive a system information from a base station; and
a controller configured to obtain a receivable broadcasting channel based on the system information.

2. The portable terminal of claim 1, wherein the controller obtains a location information of the portable terminal based on the system information, and obtains a broadcasting channel corresponding to the obtained location information.

3. The portable terminal of claim 2, further comprising a memory configured to store the location information of the portable terminal and the broadcasting channel corresponding to the location information.

4. The portable terminal of claim 3, wherein the controller obtains the location information of the portable terminal based on the system information, and reads the broadcasting channel corresponding to the obtained location information from the memory.

5. The portable terminal of claim 3, wherein when the broadcasting channel corresponding to the location information doesn't exist in the memory, the controller searches a receivable broadcasting channel in a current location of the portable terminal, and stores the searched broadcasting channel and the location information in the memory.

6. The portable terminal of claim 5, wherein the controller obtains the receivable broadcasting channel using a service information included in the received broadcasting signal.

7. The portable terminal of claim 3, wherein the controller sorts the broadcasting channel read from the memory based on a number of times for watching a broadcasting channel to represent the sorted broadcasting channel.

8. The portable terminal of claim 3, wherein the controller sorts the broadcasting channel read from the memory based on receive sensitivity to represent the sorted broadcasting channel.

9. The portable terminal of claim 2, wherein the location information is obtained based on an SID (system identification) and an NID (network identification) information of the system information.

10. The portable terminal of claim 1, further comprising a broadcast receiver configured to receive a broadcasting signal and a service information included in the received broadcasting signal.

11. The portable terminal of claim 1, wherein the controller obtains the location information of the portable terminal based on the system information, obtains a broadcasting zone where the portable terminal belongs based on the obtained location information and obtains a broadcasting channel corresponding to the obtained broadcasting zone.

12. The portable terminal of claim 11, wherein the location information is obtained based on an SID (system identification) and an NID (network identification) information of the system information.

13. The portable terminal of claim 11, further comprising a memory configured to store the location information of the portable terminal, the broadcasting zone corresponding to the location information and the broadcasting channel corresponding to the broadcasting zone.

14. The portable terminal of claim 13, wherein when the broadcasting channel corresponding to the obtained broadcasting zone doesn't exist in the memory, the controller searches the receivable broadcasting channel in the broadcasting zone where the portable terminal belongs, and stores the searched broadcasting channel in the memory.

15. A portable terminal having a function for receiving a digital broadcasting and having a function for automatically searching for a broadcasting channel, the portable terminal comprising:
a GPS receiver configured to calculate a location of the portable terminal based on a GPS signal; and
a controller configured to obtain a receivable broadcasting channel based on the location of the portable terminal.

16. The portable terminal of claim 15, wherein the controller obtains a broadcasting zone where the portable terminal belongs based on the location of the portable terminal, and obtains a broadcasting channel corresponding to the obtained broadcasting zone.

17. The portable terminal of claim 15, further comprising a memory configured to store a receivable broadcasting channel by each of broadcasting zones.

18. The portable terminal of claim 17, wherein when a broadcasting channel corresponding to the obtained broadcasting zone doesn't exist in the memory, the controller searches a receivable broadcasting channel in the broadcasting zone where the portable terminal belongs, and stores the searched broadcasting channel in the memory.

19. The portable terminal of claim 18, wherein the controller obtains the receivable broadcasting channel using a service information included in the received broadcasting signal.

20. The portable terminal of claim 17, wherein the controller sorts the broadcasting channel read from the memory based on a number of times for watching a broadcasting channel to represent the sorted broadcasting channel.

21. The portable terminal of claim 17, wherein the controller sorts the broadcasting channel read from the memory based on receive sensitivity to represent the sorted broadcasting channel.

22. The portable terminal of claim 15, further comprising a broadcast receiver configured to receive a broadcasting signal and a service information included in the received broadcasting signal.

23. A method of automatically searching for a broadcasting channel in a portable terminal having a function for receiving a digital broadcasting, the method comprising:
receiving a system information from a base station; and
obtaining a receivable broadcasting channel based on the system information.

24. The method of claim 23, wherein the obtaining a receivable broadcasting channel based on the system information comprises:
obtaining a location information of the portable terminal based on the system information; and
reading a broadcasting channel corresponding to the obtained location information from a database.

25. The method of claim 24, wherein the obtaining a receivable broadcasting channel based on the system information further comprises representing the broadcasting channel read from the database.

26. The method of claim 24, wherein the location information is obtained based on an SID (system identification) and an NID (network identification) information of the system information.

27. The method of claim 24, wherein the obtaining a receivable broadcasting channel based on the system information further comprises searching a receivable broadcasting channel in a current location of the portable terminal, and storing the searched broadcasting channel and the location information in the memory when the broadcasting channel corresponding to the location information doesn't exist in the memory.

28. The method of claim 23, wherein the obtaining a receivable broadcasting channel based on the system information further comprises:
obtaining the location information of the portable terminal from the received system information;
obtaining the broadcasting zone corresponding to the obtained location information; and
reading the broadcasting channel corresponding to the obtained broadcasting zone from the database.

29. The method of claim 28, wherein the obtaining a receivable broadcasting channel based on the system information further comprises representing the broadcasting channel read from the database.

30. The method of claim 28, wherein the location information is obtained based on an SID (system identification) and an NID (network identification) information of the system information.

31. The method of claim 28, wherein the obtaining a receivable broadcasting channel based on the system information further comprises searching the receivable broadcasting channel in the broadcasting zone where the portable terminal belongs, and storing the searched broadcasting channel in the memory when the broadcasting channel corresponding to the broadcasting zone doesn't exist in the memory.

32. A method of automatically searching for a broadcasting channel in a portable terminal having a function for receiving a digital broadcasting, the method comprising:
calculating a location of a portable terminal; and
obtaining a receivable broadcasting channel based on the calculated location.

33. The method of claim 32, wherein the calculating a location of a portable terminal includes calculating the location of the portable terminal based on a GPS (Global Positioning System) signal.

34. The method of claim 32, wherein the obtaining a receivable broadcasting channel based on the calculated location comprises:
obtaining a broadcasting zone of the portable terminal based on the calculated location; and
reading the receivable broadcasting channel from a database.

35. The method of claim 34, wherein the obtaining a receivable broadcasting channel based on the calculated location further comprises searching the receivable broadcasting channel, and storing the searched broadcasting channel in the database when the broadcasting channel corresponding to the calculated broadcasting zone doesn't exist in the database.

36. The method of claim 35, wherein the searching the receivable broadcasting channel, and storing the searched broadcasting channel in the database when the broadcasting channel corresponding to the calculated broadcasting zone doesn't exist in the database includes searching the receivable broadcasting channel using a service information included in the received broadcasting signal.

37. The method of claim 34, wherein the obtaining a receivable broadcasting channel based on the calculated location further comprises sorting the broadcasting channels read from the database based on a number of times for watching the broadcasting channel, and representing the sorted broadcasting channels.

38. The method of claim 34, wherein the obtaining a receivable broadcasting channel based on the calculated location further comprises sorting the broadcasting channels read from the database based on receive sensitivity, and representing the sorted broadcasting channels.
